(19) United States
(12) Patent Application Publication
(10) Pub. No.: US 2017/0289593 A1
(43) Pub. Date: Oct. 5, 2017

(54) METHOD AND SYSTEM FOR CREATING A PRE-FETCHING LIST FOR MANAGED CACHING IN SMALL CELL NETWORKS

(71) Applicant: INTERDIGITAL PATENT HOLDINGS, INC., Wilmington, DE (US)

(72) Inventors: Jun Li, Cranbury, NJ (US); Debashish Purkayastha, Collegeville, PA (US)

(73) Assignee: INTERDIGITAL PATENT HOLDINGS, INC., Wilmington, DE (US)

(21) Appl. No.: 15/511,386

(22) PCT Filed: Sep. 24, 2015
(86) PCT No.: PCT/US2015/051973

§ 371 Date: Mar. 15, 2017

Related U.S. Application Data
(60) Provisional application No. 62/054,726, filed on Sep. 24, 2014.
(60) Provisional application No. 62/077,685, filed on Nov. 10, 2014.

(51) Int. Cl. H04N 21/25; H04N 21/61; H04N 21/24; H04N 21/258; H04N 21/231

(52) U.S. Cl. CPC H04N 21/251; H04N 21/25891; H04N 21/23106; H04N 21/2408; H04N 21/6131

(57) ABSTRACT

Methods and systems may be used by a mobile-content distribution network (CDN) service to track individual user requests based on a correlation of a network level identifier to an application level identifier. The users may also be tracked using a mapping of the network level and application level identifiers to an internal identity. Further, the mobile-CDN service may build a cell profile using content requests from a set of active users across similar locations. Also, the mobile-CDN service may build a cell profile using content requests from user groups that have at least one member as an active user of the cell. Using a cell profile, the mobile-CDN may generate a prefetching content list for managed caching in the cell by localizing the content popularities and viewing patterns. The methods and systems may be applied in a small cell network (SCN).

### CROSS REFERENCE TO RELATED APPLICATIONS

This application is the U.S. National Stage, under 35 U.S.C. §371, of International Application No. PCT/US2015/051973 filed Sep. 24, 2015, which claims the benefit of U.S. Provisional Application No. 62/054,726 filed on Sep. 24, 2014 and U.S. Provisional Patent Application No. 62/077,685 filed on Nov. 10, 2014, the contents of which are hereby incorporated by reference herein.

### BACKGROUND

Transparent caching placement may store content into a cache upon user request. Such transparent caching placement may assume content previously requested by one user is likely to be requested again by the same user or another user under the same cache server. An advantage of transparent caching may be simplicity and may reflect the timely update of content popularity. If the user group size under a cache server is large, such as ten thousand to one million users, the likelihood of content being requested again can be large. In a small cell network (SCN), such as, for example, a network with a few dozen or fewer users, most of the network content may include one-timer objects. One-timer objects may be requested only once, and thus, may not be able to benefit from transparent caching.

Managed caching placement may store content into a cache based on a prediction of content popularity. Such managed caching placement may assume that the popularity of content can be predicted by a cache service, such as a mobile-content distribution network (CDN) or a CDN application. A cache server may receive content pushed by the cache service periodically, usually at the off-peak hours of the access network. User requests at peak hours can benefit from a local cache hit. The user requests may benefit if the popularity prediction is accurate. The better the popularity prediction, the higher the cache hit ratio may be.

### SUMMARY

In an embodiment, a method of pre-fetching content in a small cell network (SCN) by a mobile-content distribution/delivery network (CDN) service is disclosed. The method may include: determining a local content popularity for a unit of content based on one or more of a global content popularity, a global category popularity and a local category popularity for the unit of content; determining a local content viewing pattern for a unit of content based on one or more of a global content viewing pattern, a global category viewing pattern and a local category viewing pattern; and transmitting a recommendation of content based on the local content popularity and local content viewing pattern.

In another embodiment, a method of pre-fetching content in a small cell network (SCN) by a mobile-CDN service is disclosed. The method may include: tracking individual user content requests based on a correlation of a network level identifier to an application level identifier; and building an individual user profile.

In another embodiment, a method of pre-fetching content in a small cell network (SCN) by a mobile-content distribution/delivery network (CDN) service is disclosed. The method may include: identifying active users in a small cell; generating individual user profiles based on content requests from the active users in the small cell; and building a cell profile based on individual profiles of active users.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of a mobile-content distribution/delivery network (CDN) system architecture; and

FIG. 3 is a diagram of a cache enabling service (CES);

FIG. 4 is a diagram illustrating popularity localization;

FIG. 5 is a diagram illustrating viewing pattern localization;

FIG. 6 is a diagram of cache servers and a cache service;

FIG. 7 is a diagram of functional blocks for a user identifier tracking feature;

FIG. 8 is a diagram of an observed identifier to internal identifier mappings;

FIG. 9 is an example of a user tracking function;

FIG. 10 is a diagram of a user tracking function using IP address and application cookies;

FIG. 11 is a diagram illustrating merging duplicate user IDs;

FIG. 12 is a diagram of a data access rate for a small cell;

FIG. 13 is a diagram of a data space for profile learning;

FIG. 14 is a diagram of a data space expansion by individual user aggregation;

FIG. 15 is a diagram of a data space expansion by user group aggregation;

FIG. 16 is a diagram of an emulation system setup;

FIG. 17 is a diagram of example profile learning results; and

FIG. 18 is a diagram of an example of a convergence of estimation error on profile learning.

### DETAILED DESCRIPTION

Because of the drastically smaller number of users, caching solutions in a small cell network (SCN) may be very different from conventional content distribution/delivery networking (CDN) solutions in larger networks. For example, in an edge cache in a small cell, the number of content requests may not be large enough to have an effective caching replacement algorithm. In a conventional CDN, transparent caching replacement may benefit users if they request content that has been requested by others before them. In a SCN, the probability of specific content being requested repeatedly is very low.

In addition, in a conventional CDN, managed caching replacement may use statistics at the edge cache to predict a pre-fetching list of the cache. However, in a SCN, the number of requests may be too small to produce a statistically meaningful pre-fetching list.

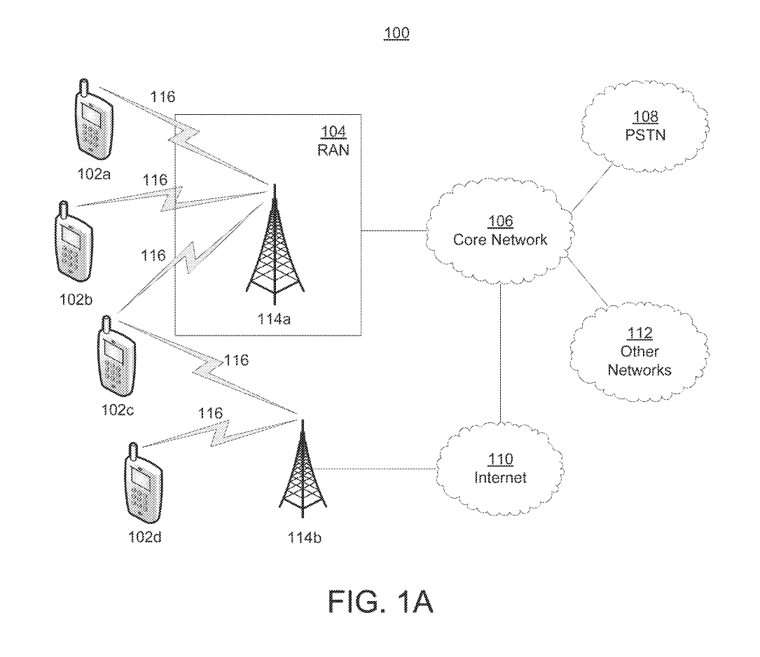

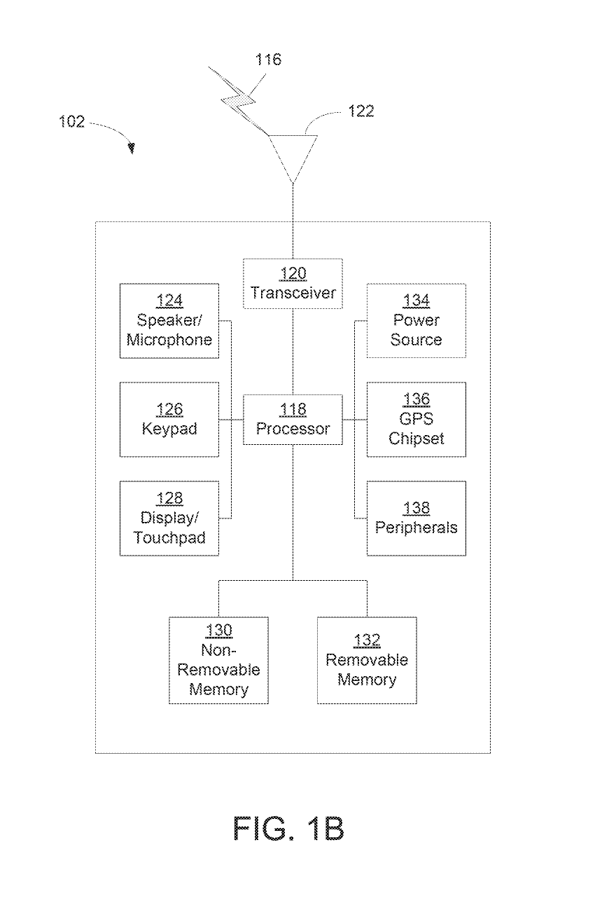

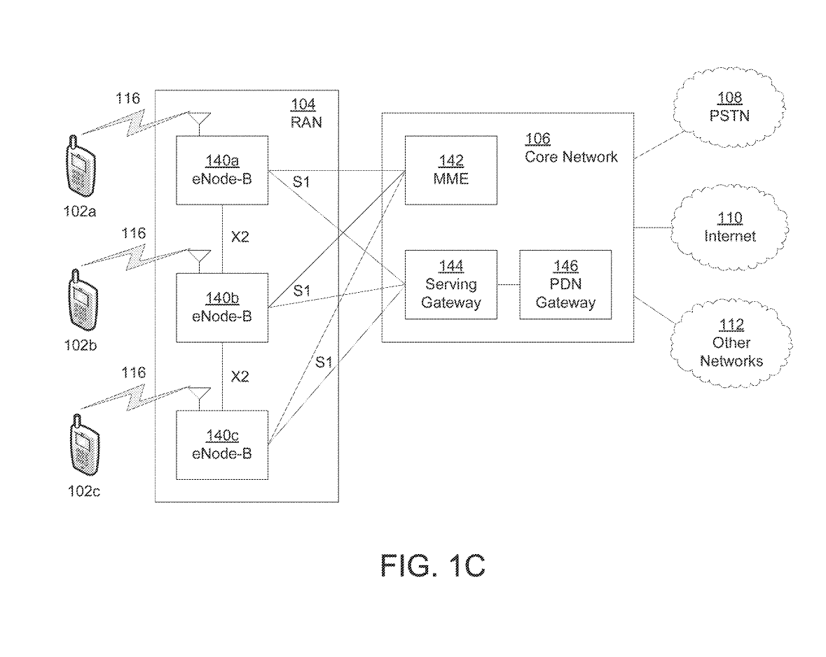

In order to cache effectively in a SCN, a managed caching placement may need to increase not only the amount of data it can use, but the effectiveness of the data for the pre-fetching list prediction as well. Embodiments described herein may a include mobile-CDN using managed caching to pre-fetch popular content for a SCN. As described below with reference to FIGS. 1A-18, the cache service system may achieve these goals by estimating local popularity based on cell profiles, anonymously tracking individual users and identifying user requests from frequent/active visitors, and/or building cell profiles based on individually identified content requests.

Referring now to FIG. 1A, a diagram of an example communications system 100 in which one or more disclosed embodiments may be implemented is shown. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

Referring now to FIG. 1B, a system diagram of an example WTRU 102 is shown. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

Referring now to FIG. 1C, a system diagram of the RAN 104 and the core network 106 according to an embodiment is shown. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

In an embodiment, a method and system may be used to track individual users to create user profiles under a small cell cache in an SCN. User profiles may be collected for each small cell cache and the popularity of content and segments of content for users under a small cell may be estimated indirectly from global statistics from content server or CDN applications.

A caching problem may be determined in mobile networks and other telecommunications networks. An objective of mobile-CDN may be to optimize an underlying mobile network infrastructure instead of an overlaying CDN. Also, the size of a mobile-CDN may be typically much smaller than a conventional CDN. Further, a pushing, or managed caching, strategy can perform more efficiently than the pulling strategy used by a conventional CDN. A genetic algorithm to may be used to establish a distribution schedule of a mobile-CDN over an internet service provider (ISP) network infrastructure. The algorithm may assume that the recommendation of content to users (or probabilities of user requests for content) may be known and it may assign the user requests to cache servers (content repositories) in the mobile-CDN according to the schedule. If the size of users served by a mobile-CDN cache is large, the recommendation can be based on past statistics. However, in an SCN cache, the statistical data may not be enough for any direct recommendation.

The caching service in the small cell network may need a content recommendation algorithm to suggest what be pre-fetch into the cache. There may be two types of recommendation systems. One type may be a collaborative filtering (CF) recommender that may use data (such as, for example, statistics or ratings or both) of a group of users who share similar interests to rate and/or rank a content list for a user in the group. For each content item i, the CF recommender may have a score S(i, u) given by each user u in the group. The total score of the item i for a user v can be defined as a weighted sum based on the similarity weight w(v, u) of the user v to user u.

Another type may be a content-based (CB) recommender that may use a user u's past statistics to rate and/or rank content list for his future use. For each content item i, the item may have a set of features Fᵢ, and the rate and/or rank of content item j may be computed based on the overlap of Fⱼ, and {Fᵢ, i∈I}, where I may be the content set previously requested by the user u.

A hybrid recommender may use both a user u's own request statistics and similar users' statistics to generate recommendation for the user u. Recommendation systems may be widely used by online content services, such as NETFLIX, AMAZON, and the like. The recommender may suggest a list of content to a user based on the rating of the content viewed previously by the user and similar users. The approach may rely on the active participation of the rating process which could be limited and biased to certain demographic of people.

View count may be a key statistic that may rate a content item implicitly by users. The popularity of a content item-i can be estimated as pᵢ=qᵢ/Q, the view count of content item-i (qᵢ) out of total content view count (Q). A recommender for cache service can simply use content popularity to determine a pre-fetching list for a given cache size.

A probability distribution of a content set may be context dependent. In other words, the distribution may depend on locations, time of use as well as category preferences of a user group. Also, content popularity may be geographically dependent. A piece of content may be popular in one region but not at all popular in another region. Further, content popularity may also be time dependent. Popularity may depend not only on the time of day, but also may vary over a life-cycle of content. The life-cycle of user-generated-content (UGC) may be relatively short. In addition, content popularity may be category dependent. For example, news content may be less location dependent but more time dependent, while sports content may be both highly location and time dependent.

While there may be no universal (global) content popularity that can fit the users in all small cells, content popularity may be estimated specific to users of each small cell. In other words, content popularity may be estimated based on the user profile of each small cell.

Further, although the mean cache of content may decrease as a user group size gets smaller, the variance of the cache performance may increase. This phenomenon may indicate if a popularity estimation fits the user profile. Further, this phenomenon may indicate that a user group with similar profiles may reach the higher end of variance of the cache performance, which may be better than the average.

Video content can take majority of cache space because the size of video content may be relatively big. A system may not be able to cache a large number of videos from a content list in popularity order since the cache space may be limited. Further, only a small prefix of video may normally be viewed, such as, for example, ten percent of the whole video length. Therefore caching the whole video may result in wasting the cache space.

Video content may be partially cached in many different ways. A segmentation approach, which may be referred to as flex-seg, may divide video content into chunks (minimum units) and segments (a set of contiguous chunks). The size and popularity of segments in a video may be determined by statistics based on the user viewing patterns of that video.

In an example, a content recommendation system for cache service may use content popularity as the ranking of a content set. As used herein, a Global Network may be a network serving a group of users independent of network locations. The group can be as big as the whole subscribers of the same ISP, or as small as the members of an interest group. Also, global content set may be used. As used herein, Local Network may be a network serving a group of users under the same location, such as a local area network (LAN), a SCN or one small cell.

As used herein, content popularity may be the probability of a piece of content being requested upon next request arrival. In an example, a system may estimate content popularity by the view-count of the content dividing the view-count of the whole content set. As view-count of a piece of content increases, the content popularity may also increase. A global content popularity may be the content popularity for all users of the global network under a content service provider, such as, for example, a mobile network CDN, an Internet CDN or a content server over the whole Internet. A local content popularity, on the other hand, may be the content popularity only for users under a local network, such as a small cell in an SCN.

As used herein, content viewing pattern may be the probability distribution of the segments of a piece of content to be viewed upon the request for the content. The viewing pattern can also be considered as the conditional “popularity” of a segment given a content that may be viewed. In an example, a system can estimate the viewing pattern of a piece of content by view counts of all segments dividing the view count of the content. Normally, the segments with smaller index may have a higher probability of being viewed. A global content viewing pattern may be the viewing pattern for all users of a content service provider and a local content viewing pattern may be the viewing pattern only for the users under a local network.

As used herein, a user profile may be a set of parameters about an individual user, which may include statistical data, such as category preference, average viewing pattern and time of access, or non-statistical data, such as location, demographics and device capability. Individual profiles may be aggregated to generate a group profile of a local network, such as a cell profile for users under a small cell.

In an example, a method and system may determine a global content popularity for a content set which is available, P={pₖ}, and a group profile, PF={pfᵢ}, of a local network. The method and system may also find a local popularity distribution, P′={p′ₖ}, that fits the group profile, PF. In a further example, a method and system may determine a global viewing pattern of a content set, U={Uₖ}, where Uₖ={u_{k,j}, j=0, . . . , Jₖ}, is available and a group profile, PF={pfᵢ}. The method and system may also find a local viewing pattern U′ₖ that best fits the group profile PF.

In an example, methods and systems may derive the popularity and viewing patterns in a local network for content without enough statistics under the local network. Further, the methods and systems may find invariants among global statistics and local statistics in order to “localize” content popularity and viewing patterns. In a global network, the statistics for both category and individual content may be available. In comparison, in a local network, since the size may be small, only category statistics may be available.

For content popularity, the invariant may be the ratio of a content k's popularity to its category y's popularity, such as, for example, the conditional popularity of content k in its category y. The invariant may be independent of the location and size of the networks.

For content viewing pattern, the invariant may be the offset of the jth segment of a content-k from its category average. For example, the conditional “popularity” of a segment within a category may be unchanged. Further, the invariant may be independent of the location and size of the networks. With the invariants, a method may estimate the local popularity and local viewing pattern in a small cell for any given content k, even if few requests may be made in the small cell.

A mobile network with small cells may contain a mobile-CDN system architecture. A mobile-CDN system may reduce the backhaul pressure of small cell eNodeBs at peak hours, providing better quality of experience (QoE) to mobile users.

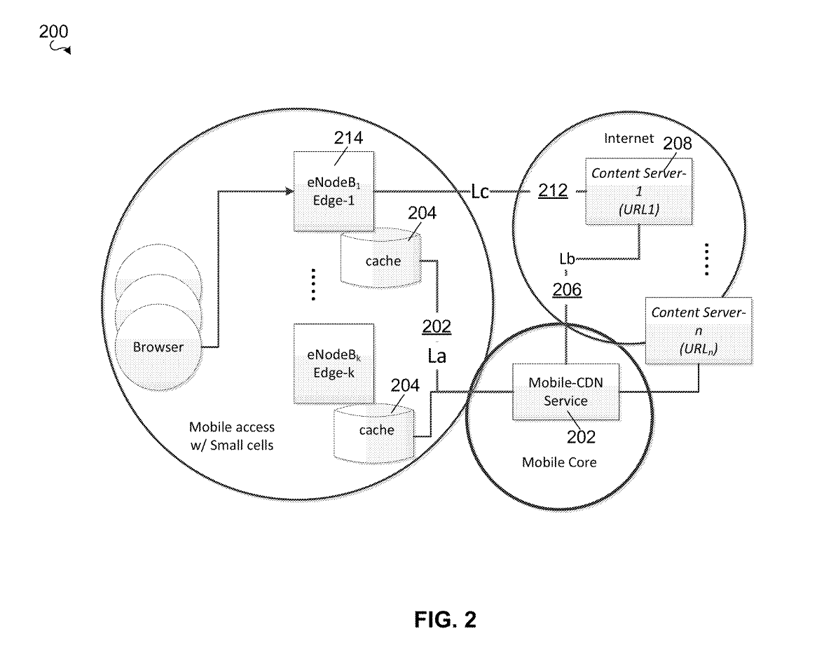

Referring now to FIG. 2, a diagram of a mobile-CDN system architecture 200 is shown. In an example, a mobile-CDN service 202 may have two interfaces, a first interface (La) 204 to edge caches 206 and a second interface (Lb) 208 to content owners 210, such as, for example, Web Apps. The edge caches 204 may be used with a SCN. The mobile-CDN 202 may facilitate the content distribution between content owners 210 and edge caches 206 through a third interface (Lc) 212. The eNode-Bs 214 may be used in a SCN.

The mobile-CDN service may have two functions. A first function may be to give or transmit recommendations of what to pre-fetch to edge servers, where a key challenge may be to match the user profiles with the content in the edge servers. A second function may be to obtain the authority to serve content at edge servers.

The mobile-CDN service may provide a cache enabling service (CES) (and other services). The CES may gather statistics from local and global networks.

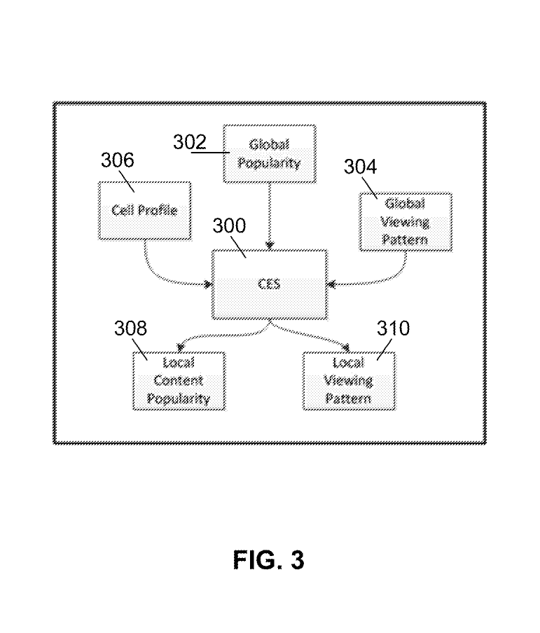

Referring now to FIG. 3, a diagram of a CES 300 is shown. In an example, the statistics may include global popularity 302 and global viewing patterns 304 from content server/CDN applications and cell profiles 306 through each eNode B. Further, the CES 300 may generate Local Content Popularity 308 and Local Viewing Patterns 310, which may be used to decide contents or segments or both which may be cached at the small cell edge cache.

Content popularity localization may include three main steps, including: global content popularity and category popularity acquisition; cell profile creation, with local category popularity; and estimation of local content popularity. Global content popularity and category popularity acquisition may include several steps. Global content statistics may be obtained or collected from content owners, such as popular streaming video providers. The local content statistics can be obtained or collected from the eNodeBs. The relevant statistics and related information may be collected using various mechanisms. The metadata associated with the content, such as category, view count, duration, and the like may be collected for use by an algorithm.

In an example, qk may be defined as the number of view counts of content k in time period T. The variable Q may be defined as the number of total content view counts during time period T. The variable Qy may be defined as the number of view counts in category-y in time period T. A content-k's popularity may be defined as the probability of the content being requested for a given period of time T, which can be estimated by:

pₖ=[qₖ]/[Q]. Equation (1)

A category's popularity may be defined as the probability of the content within category y being requested, for a given time period T, which can be estimated by:

p_{—y}=[Q_{y}]/[Q]. Equation (2)

The estimation of pₖ may only be available for the global network. In an example, only a big network can collect enough view counts on an individual content k. However, the category popularity may be available for both global and local networks.

The time window T reflects the time-varying of content popularity. The choice of T can balance the size of sampling space and freshness of the data to have the best estimation on content popularity.

A content k's local popularity at the cache server of a cell, p′ₖ, can be estimated by the global content popularity pₖ times local category popularity divided by global category popularity:

p′ₖ=pₖ*p′_{—y}/p_{—y} Equation (3)

The above equation may be used in an example where p_{k/y}=pₖ/p_{—y} is an invariant amount between global and local networks.

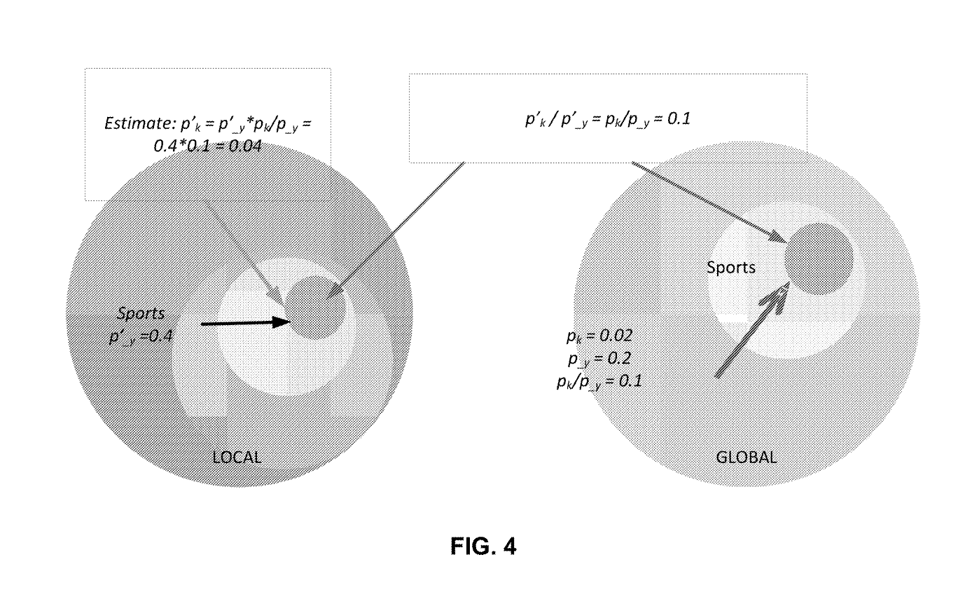

Referring now to FIG. 4, a diagram illustrating popularity localization is shown. In an example, the global popularity of content k may be 0.02. Its category, sports, may have a global category popularity of 0.2 (20% of content requested may be in the sports category). Further, the conditional probability of content k may be 0.1. The content may be very popular over the time period of T. In a small cell which may have only few people, for example, at a home, even if content k is very popular, there may be no statistics about it locally. Since the small cell may have the local category popularity for sports as 0.4, which is much higher than (double) the global category popularity, the estimated popularity of content k may be localized to a higher value as 0.04, and may be doubled as the category popularity doubled.

Viewing pattern localization may include three main steps, including global content and category viewing pattern acquisition, cell profile creation, with local category viewing pattern, and estimation of local content viewing pattern. In an example, the viewing pattern (u_{k,j}) of video content is defined as the probability of a segment being viewed if the content is requested.

In an example, q_{k,j} may be the view count of segment j for content k and qₖ may be the view count of content k. The viewing pattern can be estimated over a period of T by:

u_{k,j}=[q_{k,j}]/[qₖ]. Equation (4)

This equation may estimate the conditional probability of segment j to be accessed if content k is accessed. In an example, since content may have different size/length, in order to get a category average of content with different lengths, a normalized length viewing pattern may be defined as Uₖ={u_{k,j}, j=0, . . . , J}, where J may be a fixed number for all content in a category. For example, if J=99, all content may be normalized to 100 segments. As a result, if content A is twice as long as content B, the segment size of content A may be twice the segment size of content B.

The viewing pattern of a category may be defined as the average viewing pattern of all content in a category. In an example, a total of K content requests may be made over a period of T, the category viewing pattern may be:

u_{y,j}=Σₖ₌₁^{K}u_{k,j}/K. Equation (5)

In a small cell, the user preference on the viewing pattern can be collected over different categories, although the viewing pattern of a particular content k may not be available. Local users may view content in one category more completely than the other. For example, people may be more likely to complete a movie than a lecture. However, for people with different category preferences, the viewing patterns for categories may be different. Further, the category average of viewing patterns can be collected as one profile parameter for individual users and then aggregated to a cell profile for a small cell.

In an example, the viewing pattern at a global network for individual content k and category y may be U_{y}={u_{y,j}} and Uₖ={u_{k,j}}, respectively. These are statistics may be collected by the global network or content operators. Further, the local category viewing pattern, U′_{y}={u′_{y,j}} can be obtained through the small cell usage data at the segment level. The invariant may be the offset of the content viewing pattern from the category average, which may be seen in equations (6) and (7). In an example, if u_{k,j}>u_{y,j}:

(u′_{k,j}−u′_{y,j})/(1−u′_{y,j})=(u_{k,j}−u_{y,j})/(1−u_{y,j}). Equation (6)

In another example, if u_{k,j}<u_{y,j}:

(u′_{y,j}−u′_{k,j})/u′_{y,j}=(u_{y,j}−u_{k,j})/u_{y,j} Equation (7)

Equation (6) may mean if the global viewing pattern for segment j of content k is greater than the category average, the local viewing pattern may also be greater than the category average in the same percentage or ratio as the global viewing pattern. Equation (7) may mean if the global viewing pattern for segment j of content k is smaller than the category average, the local viewing pattern may also be smaller in a same percentage or ratio.

In the equations (6) and (7), only u′_{k,j} may be unknown. Therefore the local viewing pattern of content k, U′ₖ={u′_{k,j}}, can be estimated by the following equations. In an example, if u_{k,j}>u_{y,j}:

u′_{k,j}=(u_{k,j}−u_{y,j})*(1−u′_{y,j})/(1−u_{y,j})+u′_{y,j}. Equation (8)

In another example, if u_{k,j}<u_{y,j}:

u′_{k,j}=u′_{y,j}−(u_{y,j}−u_{k,j})*u′_{y,j}/u_{y,j}. Equation (9)

In another example, if u_{k,j}=u_{y,j}:

u′_{k,j}=u′_{y,j}. Equation (10)

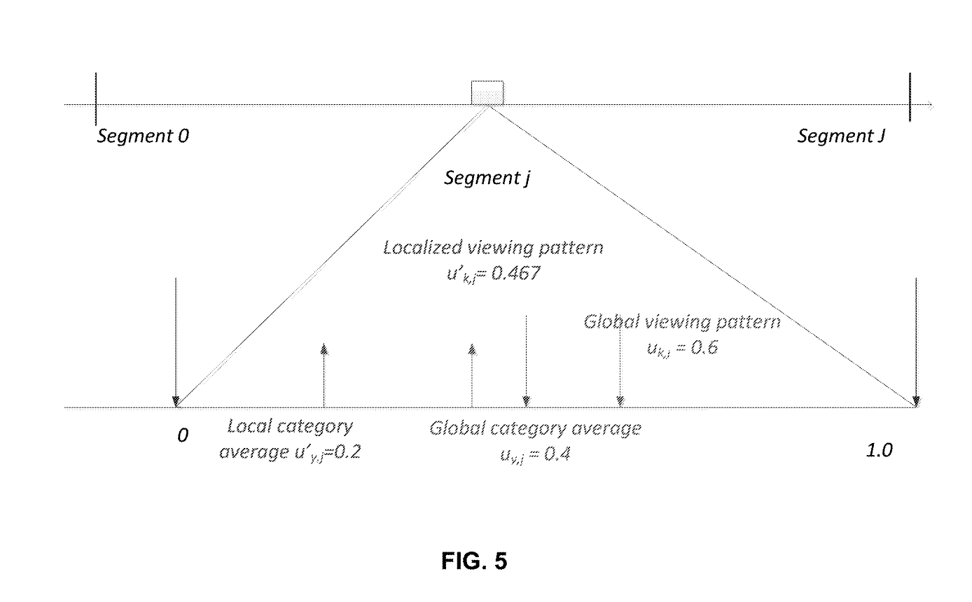

Referring now to FIG. 5, a diagram illustrating viewing pattern localization is shown. In an example, a given segment j may have a global viewing probability (or global viewing pattern) for content-k of u_{k,j}=0.6, which may mean 60% of requests directed to content k viewed the segment j. Further, a global category viewing pattern for category y may be u_{y,j}=0.4, which may mean 40% of content requests in the category y have accessed segment j. In an example, a method may collect the cell profile of a small cell that includes an average viewing probability for of segment j in category y as u′_{y,j}=0.2 and therefore calculates the viewing probability for segment j of content k estimated as u′_{k,j}=(u_{k,j}−u_{y,j})*(1−u′_{y,j})/(1−u_{y,j})+u′_{y,j}=0.2*0.8/0.6+0.2=0.467 using Equation (8). Applying the calculations segment j, we can get the localized viewing pattern of content-k, U′ₖ={u′_{k,j}}.

In an example with the localized viewing pattern, partial video caching can be performed based on the popularity of segments. The popularity of segment j of content k may equal p′_{k,j}=u′_{k,j}*p′ₖ. The cache service of a mobile-CDN can list content segments by sorting their popularity {p′_{k,j}, k=1, . . . , K, j=1, . . . , J} and cache segments one by one until the cache is full. As used herein, the caching unit may be a segment of content, a piece of content or a content item. The popularity based caching policy may remain the same. In a further example, a segment of a high popularity content may have a lower segment popularity than a segment of a lower popularity content. For example, content X ranks number one and may have its 50th segment less popular than the 10th segment of content Y. In this way, more content can be cached, though partially, in the same cache size.

The method and system disclosed herein may apply to content and other types of media, such as, for example, audio files, ebooks, long text files, and the like. As used herein, a category may be determined by a set of tags representing the attributes of content. The media type can be one attribute of content. In an example, the viewing pattern localization algorithm may normalize the length of content within one category into J segments in order to obtain a category average. The algorithm does not necessarily require the number of segments of content, J, to be the same for all categories. The number of segments of content can be category dependent, that is J for category y. For example, for text files and files of audio recordings, J can be small, and for ebooks and videos, J can be large. Within a media type, the news can have a smaller J and movies can have a large J.

As disclosed herein, two parameters in a user profile, category preference and average category viewing pattern, may be used for localizing content popularity and content viewing patterns. In a further example, additional parameters may be used in a user profile to perform statistical localization. For example, the mobility pattern can vary the content popularity over a time period, such as time of day or day of week or both. As disclosed herein, global statistics are made to adapt to a local user profile.

In another embodiment, a method and system are disclosed herein for transparently using anonymous identifiers and network provided identifiers to track individual user requests and build individual user profiles in a small cell. Further, a method and system are disclosed herein for managing active, frequent visitor to a small cell. Also, in another embodiment, a method and system are disclosed herein to identify a set of active users in a small cell and build a cell profile by using all content requests from this set of users, regardless of their location. In addition, a method and system are disclosed to classify mobile users into groups of similar individual profiles and to build a cell profile by using all content requests from user groups that have at least one member being an active user of the cell.

As used herein, a user profile may be a set of parameters that reflect the content request features (or behaviors) of a user or a group of users. As an example, the following parameters may be used in a user profile, but a user profile may not be limited to this set: Site preference; category preference; recently accessed content; video internal viewing pattern (retention, trick mode etc.); web browsing viewing pattern (average depth, average speed etc.); access time distribution (day of week, hour of day, vacations); access location distribution (home, work, public hotspots); device capacity; and demographic information (age, gender, ethnic, language etc.).

Most user profile parameters can be expressed as a random process r={r(n), n=0, 1, . . . } and obey a probability distribution p(n)={pₖ(n)}, that is, Prob (r(n)=k)=pₖ(n). For example, the category preference may be a distribution p(n)={pₖ(n)} with the request arrival at time n, and have a probability of pₖ(n) belonging to a content in category-k. In general, a category may simply be a tag to a content, which can be very rough (for example, popular streaming video services may have 17 big categories) or details with sub-categories. More categories may lead to more detailed user profile and better targeted pre-fetching list prediction. However, less data in each category can lead to a poor estimation on the category preference distribution and therefore less accurate pre-fetching list prediction.

As used herein, an individual profile may be the profile of an individual user. The individual profile of a user can be built based on the Internet usage of the user over different periods of time, at different network locations, from different devices/platforms and/or to different web applications. A user profile across location, platform and/or domain may be possible only if the user can be consistently identified (or uses a consistent identifier) across different locations, on different platforms and to different application domains.

As used herein, a group profile may be the profile of a group of users with similar individual profiles. The similarity of any parameter in the user profile may depend on the algorithm used for user classification. It may be a challenge to create group profiles based on raw content request data without first creating individual profiles. Then the normal way can be first to create individual profiles and then to classify them into multiple groups. The number of groups may depend on the system resource. More groups may lead to a better classification with stronger similarity of users within a group.

As used herein, a cell profile may be a user profile under a small cell, at the lowest hierarchy of the cache network. A cell profile can be used to determine the pre-fetching list targeted to frequent visitors of the cell. The cell profile can be dynamic according to the dynamic activity of users. For example, an absent user may be precluded from the cell profile during his/her absence.

Under managed caching placement, users may benefit from a local cache hit. A better popularity prediction may result in a higher cache hit ratio. A challenge of managed caching placement in a small cell network (SCN) may be that very few statistics can be used for the prediction of the content popularity in a small cell.

A method and system are disclosed herein to track individual users at edge servers by associating two or more asynchronous user identifiers from content requests and mapping them to an individual user ID. The method may track a user across locations, applications and/or devices. The method may be transparent to users and web applications. In other words, no client and/or server support may be required. The tracked user list can be used by mobile-content distribution network (CDN) service to create individual user profiles.

As described above, in order to cache effectively in a SCN, a managed caching placement may need first to increase the amount of data and second to increase the effectiveness of the data for the pre-fetching list prediction. The cache service system can achieve these goals by tracking individual users and building their profiles. First, with individual user identities and their profiles, the user request information can be collected across different locations. The data of each user can be aggregated over time and locations. Second, by tracking individual users activities, the statistics used to predict the pre-fetching list for an edge cache can be dynamically aggregated—including only the active and frequently visited users and excluding temporary visitors.

Examples are disclosed herein of user identities that could be intercepted by an edge cache proxy at different levels, such as device, application and/or service specific identities. Further, disclosed herein are examples of using each of these identities for individual user tracking and a method of using application specific cookies plus IP address jointly to track individual users. This method may be transparent to both content owners and content users; and it may rely on no third party, such as mobile operator's support, to identify users who make requests under a proxy server with the edge cache.

In order to build user profiles and enhance the performance of edge caching in a SCN, tracking individual users may become necessary. Tracking dynamic activities of each individual user can make a big impact on creating the cell profile because every user in a small group may be significant. On the other hand, for a small cell, tracking individual users' activities may become possible due to a limited number of users in each cell and such activities may be less dynamic than a big, public cell in mobile networks.

A mobile-CDN cache service may use proxies at edge servers to collect content request statistics. A proxy may intercept hypertext transfer protocol (HTTP) requests which contain no consistent user identifiers for individual users. Since HTTP may be stateless, two consecutive requests appearing from different users may be actually from the same user. The proxy may use one of the following example identifiers to track individual users: a device specific identifier, an application specific identifier and a service specific identifier.

In general, a mobile network may have an access control (AC) function that authorizes the connectivity of a mobile device to the SCN. In mobile operator networks, this may be the authentication, authorization and accounting (AAA) function at MME. The AC function may be able to verify a mobile device with its international mobile station equipment identifier (IMEI), MAC and/or internet protocol version 6 (IPv6) address and enable blocking of unauthorized devices.

The cache service can use the IPv6 address as a device identifier to build user profiles since it may be visible by the cache proxy. In case some devices use temporary IPv6 without an embedded MAC address due to privacy concerns, the IP address may not map to a unique user identifier.

A device level identifier may limit the statistics to a single device. If a user has multiple devices, the content request data may not be jointly applied to a single user profile. Each device may be treated as an independent user, which may have less data to build a user profile.

If the device specific identifier is not available, the cache service can use an application specific user identifier to trace the user content requests. Application specific user identifiers may be widely used in Internet applications, which may normally be implemented through cookies—anonymous identifiers. A cookie may be assigned by the application server to a client and stored at the client (browser). The cookie may be included in the HTTP header of the subsequent requests to the same server. Although the HTTP protocol may be stateless, the server can correlate subsequent HTTP requests from the same client by using the cookie as the identifier of the client.

An application specific identifier may be limited to the application domain, the client program (browsers) and its lifetime. The cache service can use an application specific identifier to identify a user accessing a particular domain through a particular browser during a period of time. As a result, the sampling space of user data may be further chopped down to a smaller subspace with even less data to build user profiles.

Web services may provide service specific identifiers. As an example, a web services provider may provide three types of service specific identifiers. The first is may be an identifier for data analysis purposes that can provide individual user statistics to a web application. The data analysis identifier may use a common cookie name but different values for different web applications. Content requests to the same application domain can be identified to the same requester.

The second type may be an identifier for advertisement purposes that can offer targeted advertisement based on user profiles. The advertisement identifier may be used across application domains, that is, both the name and value of the cookie may be the same under an advertiser provider net domain. Any web application which uses the application programming interface (API) provided by the advertiser may include the advertisement identifier (cookie) in its content requests so that targeted advertisement can be generated and embedded in the response pages.

The cache service, which may intercept the content requests, can use the above identifiers to identify the requesters. The data analysis identifier may be limited to one application domain or few domains of the same owner. The advertisement identifier can be used across application domains but it may still be device/platform specific. A user with multiple devices may be identified as multiple users.

A third type of service specific identifier may be a “Generated Account Identity.” As long as a user signs into the same account with the web services provider, the client may be identified to the same user across different platforms. However, the identifier may be maintained internally by the domain of the web services provider, the value of the cookie (e.g., session identifier (SID)) may be different for different platforms and application domains. A cache service may not use a web services account cookie in content requests to identify the same user using multiple platforms.

Under the same principle of the web services provider specific identifier, a mobile-CDN can also create its own service specific identifier, which can be implemented as follows. When a user device accesses the SCN, the first content request may be redirected to a mobile-CDN portal. If the user agrees to sign up the cache service, a third-party cookie may be generated for the cache service. Once a user is signed on the mobile-CDN portal, a service specific API may be available for web applications to use if they want their content be cached (i.e., to include the cookie in their web pages), which may be the same way as if they use web services provider specific API. If the mobile-CDN would like to use the user ID across platforms, it can assign the same cookie for a user regardless what platform the user is using.

A comparison may be made of different types of identifiers. Table 1 shows identifiers at different levels. With certain limitations, example methods disclosed herein can use existing identifiers used by either web applications or client devices to identify requesters and generate user profiles accordingly.

### User Identifiers at Different Levels

TABLE 1

| User | | | |
|---|---|---|---|
| Identifier | | | |
| Type | Examples | Requirements | Limitations |
| Device | Phone#, IMEI, | MNO API, cross | MNO support, per |
| Specific | MAC | layer information | device only |
| Network | IP | No | Temporary, |
| Specific | | | location |
| Application | Domain | No | Unable cross |
| Specific | Cookies | | domains |
| Service | Third Party | Application | Unable cross |
| Specific - | Cookies | adoption and client | platform, |
| Google | | APIs | because only |
| APIs | | | Google knows |
| | | | unique ID |
| Service | Third Party | Application and | Reveals user ID |
| Specific- | Cookies | client adoption to | everywhere |
| cache | | cache service API | |
| service | | Users' explicit | |
| APIs | | sign-up, | |

Tracking device level identifiers can raise privacy concerns because they can be easily mapped to the real identity of users. For example, a mobile operator may not share an encrypted mobile subscriber identity (EMSI) number (MAC) with a third party cache service. Even if the cache service is an internal service of the mobile operator, using identifiers equivalent to users' true identities to track individual users may raise legal issues. Tracking a service level identifier, such as google API, may have less privacy concerns because users may have acknowledged the tracking already, but the requirement on web applications to include the service API may limit traceable content requests.

The network specific IP address and application specific cookies may be anonymous. They may be dynamic identifiers and renewed over time. They may be available to cache proxy transparently from clients, applications or third party APIs.

Examples are disclosed herein of user tracking for individual user profile creation. Existing identifiers at different levels may not be directly used for individual user tracking, as shown by the following examples. The device identifier may require mobile operator support and may be difficult to implement in third party cache service over heterogeneous SCNs due to privacy concerns. Further, the IP address can be valid only at one location and to one device. Also, application specific cookies may not uniformly exist for different users. Some users may prefer one application and some may prefer another. In addition, the cookies may be valid for only a period of time. Further, the service specific Identifier may exist only if an application adopts it and/or user signs in to the service portal (for example, the web services provider API). Also, the service specific Identifier may often be dynamic and/or hidden in HTTP secure (HTTPS) sessions due to privacy concerns.

Introducing a mobile-CDN service specific identifier may raise privacy concerns, and it may not be practical to require applications' adoption and users' constant sign-in. A solution of user tracking that uses a combination of existing identifiers, transparently to applications and users, is disclosed herein. The data associated with each user identifier may be intercepted and collected by a mobile-CDN service that may create a profile for each identified user.

Not all identified users may be active and frequent visitors of a cell. Some users' data can be the “noise” of a cell profile. An algorithm to manage active user list in a small cell may be expected to dynamically reflect a set of frequent visitors for the next caching cycle.

A method of utilizing available identifiers, transparently, is disclosed herein. The identifiers may include, for example, anonymous identifiers, such as cookies in HTTP headers, and network provided identifiers, such as IP addresses. The identifiers may track individual user requests and then build individual user profiles.

Methods disclosed herein may correlate a network level identifier, such as an IP address, to application level identifiers, such as application specific cookies. Since two types of identifiers may not update at the same time, the mobile-CDN service can map them to an internal identity to track users. A content request with existing IP address and/or cookies can be identified as a request from an existing user with an internal ID managed by the mobile-CDN service. Otherwise, a new internal user identity may be created for the mobile-CDN service.

Methods disclosed herein may include active user management. A mobile-CDN service may maintain a user list for each cache proxy it manages. Users on the list may be classified into frequent visitors and infrequent visitors. The frequent visitors may be further classified into active visitors and inactive visitors (for example, a visitor on vacation). The mobile-CDN service may create a cell profile based on individual profiles from the active, frequent visitors.

Although, in principle, the caching network architecture may be independent of underlying network infrastructure in a mobile network, there may be a cache proxy at each Access Point (WiFi AP/eNode B). They may be controlled by the mobile-CDN service, as part of network as a service platform for example, owned by the network operator or third party providers. A cache (mobile-CDN) service can manage multiple cache proxies across different network locations.

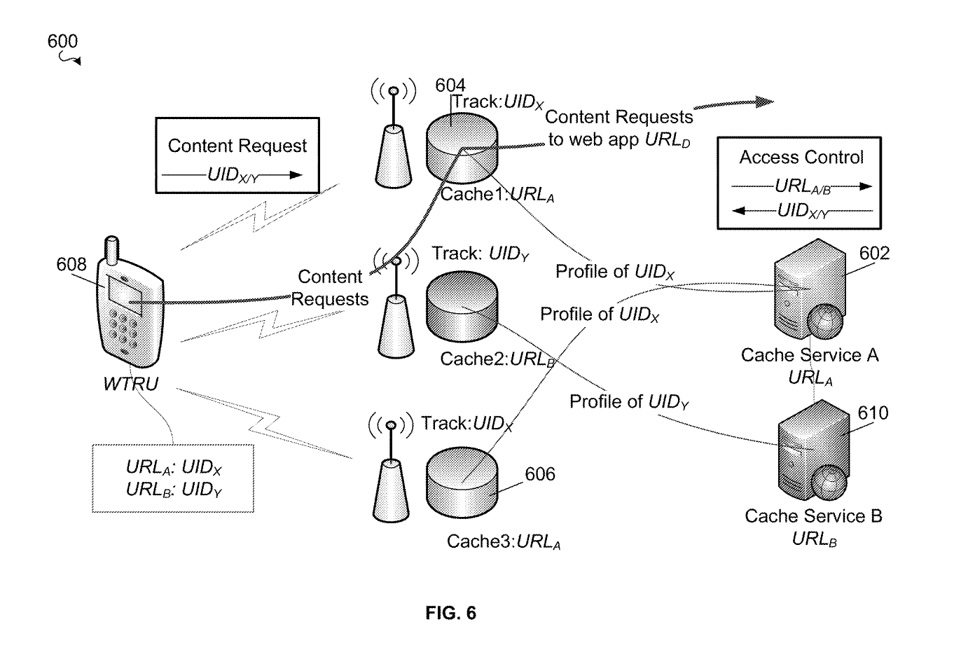

Referring now to FIG. 6, a diagram of cache servers and a cache service 600 is shown. FIG. 6 shows that cache service-A 602 may manage cache proxies cache-1 604 and cache-3 606. The same user device WTRU 608 may be identified by service-A 602 as UIDₓ and by service-B 610 as UID_{y}. Each service may collect its own statistics to build a profile of WTRU 608. However, if the user identifier can be used across different locations (likely different applications as well), the statistics collected by cache-1 604 and cache-3 606 may contribute to a single user profile.

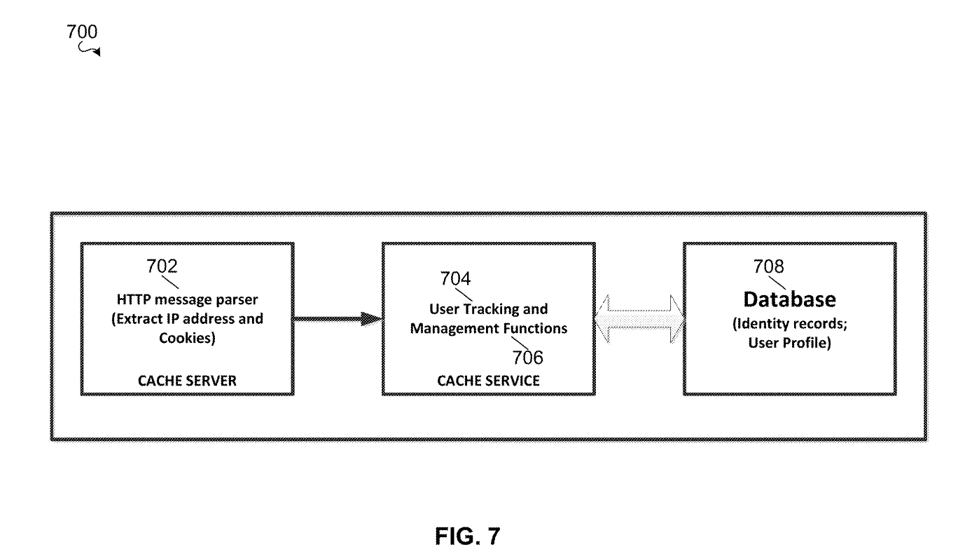

Referring now to FIG. 7, a diagram of functional blocks for a user identifier tracking feature 700 is shown. As shown in FIG. 7, user identifier tracking may include the following functional blocks: HTTP message parser 702, user tracking function 704, identifier management function 706, and database 708. The HTTP message parser 702 may intercept users HTTP request and extract the IP address and any cookie embedded within the HTTP request. The IP address and the Cookie information may be forwarded to user tracking functions 704 and management functions 706 in the Cache Service. The user tracking function 704 may query the database to retrieve available internal user ID based on the information sent by the HTTP message parser 702. Using the retrieved user identifier, the tracking function 704 may create and update user profiles. The identifier management function 706 may conduct analysis of the cell visiting pattern of individual users to classify them to frequent/infrequent and active/inactive users. The database 708 may hold internal user identifier records and a user profile per identified user.

HTTP requests from a browser may reveal different levels of identifiers, including cookies and IP address. In general, the methods disclosed herein may use two or more traceable identifiers which may not be updated at the same time to track a user. The methods disclosed herein can use their overlap time to correlate multiple identifiers. For example, cookies may not be updated at the same time as IP address renewal. A set of cookies and IP addresses may be associated to one user Identifier because of the correlation.

The cache service may maintain three lists. The first list may be an internal user identifier list for mobile-CDN service: U={Uₘ}. The second list may be an identifier-1 list: X={Xᵢ}. The third list may be an identifier-2 list: Y={Yⱼ}. As an example, an IP address may be used as identifier-1 and a cookie of a website may be used as identifier-2. Further, two mapping may be made in the database: an IP address to internal user identifier mapping I₁={(Xᵢ, Uₓᵢ)}; and a cookie to internal user identifier mapping I₂={(Yⱼ, U_{yj})}, one map list per application cookies.

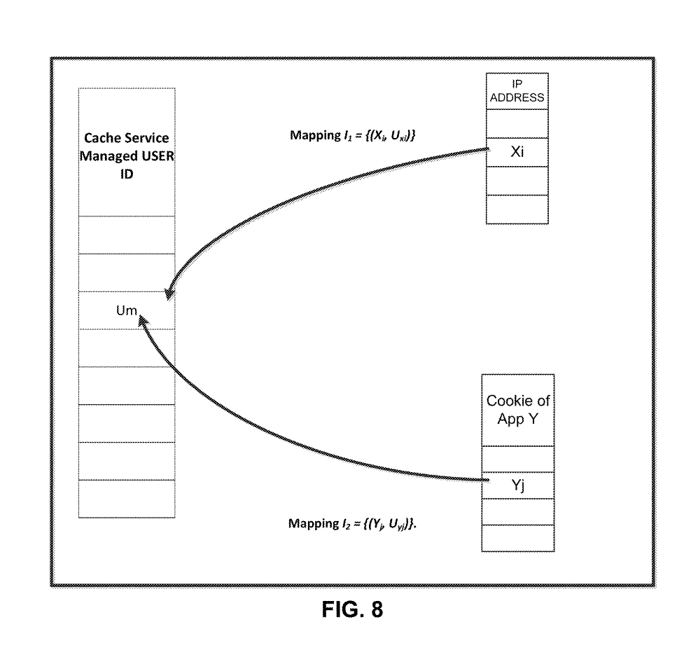

Referring to FIG. 8, a diagram of an observed identifier to internal identifier mappings is shown. FIG. 8 shows an example of the data model used in the methods disclosed herein.

The HTTP message parser (or processor) may be part of the cache proxy function. It may responsible for extracting an “IP address” and “Content Related Information” from the HTTP requests. An IP address may be extracted in different ways, including ways which are well known to those of ordinary skill in the art. Further, cookies may be included in the header request as:

Cookie: LOGIN_INFO=jfkjasjfdkasjfdsa8yugoir3q;

SSID=f3ab56520d1a459994aa01523d01ab9d

Host: www.youtube.com

The proxy may extract a cookie. For example, the proxy may extract the cookie LOGIN_INFO@www.youtube.com=jfkjasjfdkasjfdsa8yugoir3q.

After the HTTP message parser extracts observed identities, the user tracking function may map the observed identifiers to internal user identifier Um through following example algorithm. Assuming a user device makes a new request with a dynamic IP address X₁, and embeds a cookie Y₁ for an application domain, the cache service can identify the user device through following steps. An example may use a new IP address and cookie. If X₁ ∉X and Y₁ ∉Y, the method may create a new user ID U₁, and add U₁, X₁ and Y₁ into the lists U, X and Y, respectively; and may add (X₁, U₁) and (Y₁, U₁), into mappings I₁ and I₂, respectively. A new user U₁ may be identified.

Further, an example may use a new IP address. If X₁ ∉X and Y₁ ∈Y, the method may find (Y₁, U_{y1}) from I₂, and insert X₁ and (X₁, Uₓ₁=U_{y1}) into X and I₁, respectively. If a map (X′₁, U_{y1}) exists, the method may remove it from I₁. User U_{y1} may be identified. Also, an example may use a new cookie. If X₁ ∈X and Y₁ ∉Y, find (X₁, Uₓ₁) from I₁, and the method may insert Y₁ and (Y₁, U_{y1}=Uₓ₁) into Y and I₂, respectively. If a map (Y′₁, Uₓ₁) exists, the method may remove it from I₂. User Uₓ₁ may be identified. A further example may use an existing IP address and cookie. If both X₁ ∈X and Y₁ ∈Y, the method may find (X₁, Uₓ₁) and (Y₁, U_{y1}) from I₁ and I₂, respectively. If Uₓ₁≠U_{y1}, the method may replace (X₁, Uₓ₁) with (X₁, U_{y1}) in I₁. User U_{y1} may be identified.

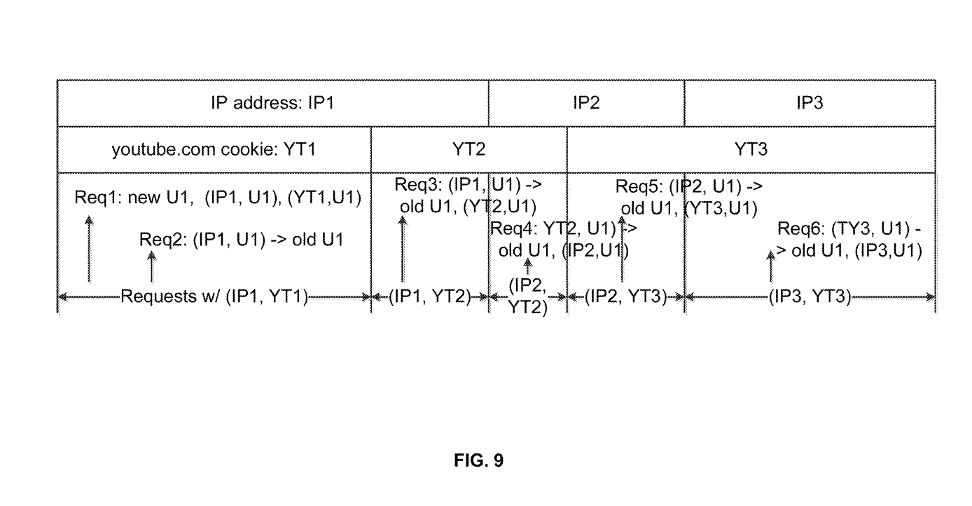

Referring now to FIG. 9, an example of the user tracking function is shown. FIG. 9 is a diagram illustrating the tracking users via identifier overlaps. The cache proxy may an extract IP address and youtube.com cookie from the requests to youtube.com. The IP address renewal and cookie renewal may be at different times. At the first time a user makes a request (Req1) to youtube.com under a proxy managed by the cache service, a new user Identifier may be created, U1 in user list U, IP1 and YT1 may be inserted into Identifier list X and Y, respectively, and maps of (IP1, U1) and (YT1, U1) may be added into the map list I₁ and I₂, respectively. The Next request (Req2) may have the same (IP1, YT1) Identifier pair, therefore the request may belong to U1. The third request (Req3) may have an identifier pair of (IP1, YT2). The method may still determine the request is from U1 because of (IP1, U1) is found in I₁. The map list I₂ may be updated with a new map (YT2, U1). A track of U1's requests can be kept as long as two identities overlap over time.

The Identifier tracking function may have pre-knowledge about the cookies of popular sites, such as youtube.com. For each popular site-k having potential cache value, the cache service can create a cookie list Yₖ and a map list Iₖ. The lists may be updated by the cache proxy upon receiving each content request to the site-k.

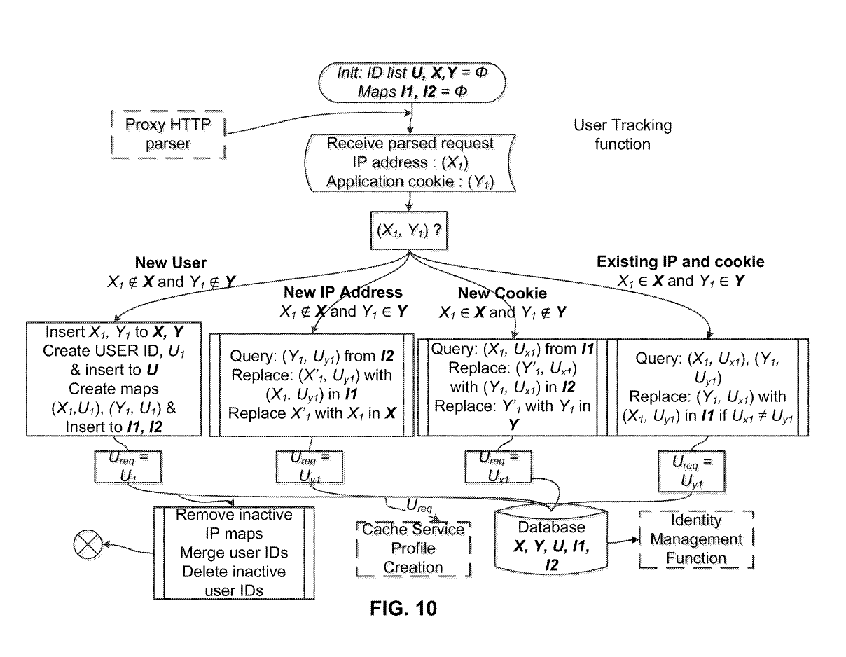

Referring now to FIG. 10, a diagram of a user tracking function using IP address and application cookies is shown. FIG. 10 shows a flow chart of a decision making process of the user tracking function. The algorithm may include the following procedures to maintain all of the lists: remove inactive IP mapping, merge user IDs, and delete inactive user IDs.

The method may remove inactive IP mapping. In an example, the dynamic host configuration protocol (DHCP) lease time may be T in a small cell. If no request with an existing IP address X₁ is received for T/2, the mapping of (X₁, Uₓ₁) may be removed. This may be to prevent X₁ ∈X being assigned to a new device because the old device leaves the cell and the IP address lease expired. Normally, DHCP server may not reuse the IP address immediately after the lease expired unless the address pool is used up. If the address pool is much bigger than the active users, this action may not be necessary.

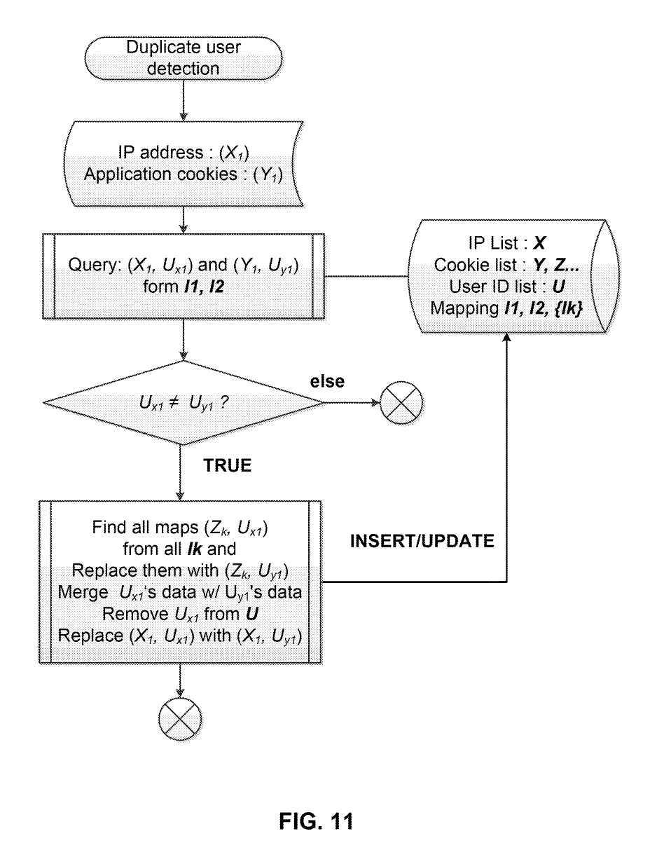

Referring now to FIG. 11, a diagram illustrating merging duplicate user IDs is shown. If two user IDs later found to be the same, they may be merged. The duplication can happen if more than one application specific cookies are used. Assuming (X₁, Y₁), (X₂, Z₁) are received, they may be mapped to two user IDs, U_{y1}≠U_{z1}. But if later the cache proxy receives (X₂, Y₁), but Uₓ₂=U_{z1}≠U_{y1} may be detected. This correlates Y₁ and Z₁ to the same user. Then the method may set U_{z1}=U_{y1} and update the map (Z₁, U_{z1})∈I₃. The merging can be processed to all application cookie list {Zₖ} and their mapping lists {Iₖ}.

The method may delete inactive user IDs. Users, who are not active for a long time may be removed from the database. A most recent access time tₘ may be added to the user list U={Uₘ, tₘ}, which is updated every time the user Uₘ makes a content request. Uₘ may be removed from U if tₘ expires after a timeout period (time out period may be set to a week, a month or a year).

The method may include an active user management function. A cell profile can be created by aggregating the user profiles of the frequent visitors of the cell. A user can move across different cells over different time period.

For each identified user on the user list U, the method may define an average access rate of user-m for cell-n as f_{n,m}(t), which is the average data rate user-m offers to cell-n the over a time period. In general, the average access rates may be a matrix F_{N×M}(t)={f_{n,m}(t)} for N small cells and M users. Time t can be hours of a day and/or days of a week. For each small cell, there may be Mₙ<<M number of users; and for each user, there may be Nₘ<<N number of cells the user may access. f_{n,m}(t) may be computed based on long term statistics, for examples, over a month or a year.

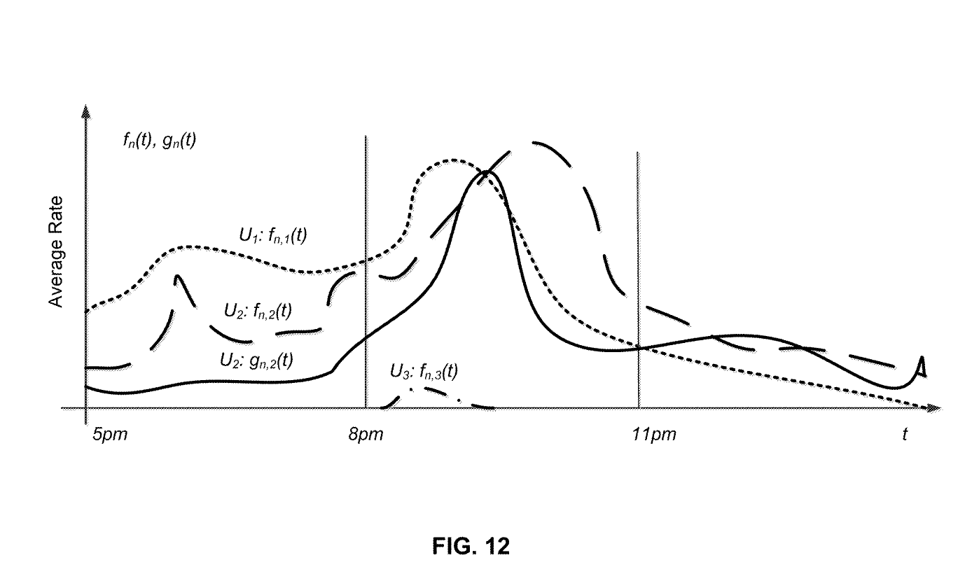

Referring now to FIG. 12, a diagram of a data access rate for a small cell is shown. FIG. 12 shows an example of three users' average access rates for a small cell-n. For cell-n, the cache service may manage its user identifier list according to the value of f_{n,m}(t). In an example of data access, the active user management function can exclude U₃ from the frequent user list U′ₙ={U₁, U₂} because its accumulative rate bellows a threshold. Only profiles of users on U′ₙ may be used for a cell profile creation.

The method may also define an instant access rate of user-m for cell-n as g_{n,m}(t), which may reflect the instant data rate user-m will offer to cell-n in last few caching cycle (e.g., past days). The variable g_{n,m}(t) may be computed based on short term statistics, for example, less than a week; and may incorporate external information like a user's vacation etc. In an example shown in FIG. 8, only U₂ may be an active user, i.e. the user management can further exclude U₁ from the active user list U″ₙ={U₂}. Only profiles of users on both U′ₙ and U″ₙ may be used for a cell-n's profile creation, i.e., active and frequent visitors' profiles may be included for a cell profile integration.

The method may also build an application cookie database. An example tracking algorithm may face a challenge in choosing application cookies. Since the frequently used web applications may be different from users, the proxy may need to track many different web applications to track multiple users. An example method may build a database to list the best cookies to track for popular web applications, which may need the knowledge to understand the context of cookies within each application and to select cookies related to content requests of interest.

In another embodiment, a method and system may be used to track individual users' identifiers and managing an active user group for each small cell. Methods and systems are disclosed herein of generating individual user profiles and then aggregating to a profile of a small cell representing the active users under the cell. The small cell profile can be used to create local content popularity and/or viewing pattern.

A method and system is disclosed herein of user profile learning for small cells in a mobile network. A challenge of user profile learning for small cells may be lack of user requests from each cell. A learning algorithm may not have enough data to estimate the user profile statistically. A method and system disclosed herein may use two approaches to expand the data space for profile learning. First, the method and system may assume a user may have a similar profile at similar locations. Accordingly, the method and system may use data from multiple locations to estimate the profile at a single location. Second, the method and system may assume a group of users may have similar profiles. The method and system may use data from multiple users in a group to estimate the profile of one user.

It should be noted that the profile learning described herein, may be one of three tasks for small cell edge caching. Based on individual user tracking and management, as disclosed above, the method and system may identify requests from users and learn individual users' profiles, which may the base for cell profile learning. Based on the cell profile learned by the method and system disclosed herein, the local content popularity and viewing pattern may be predicted, which may be derived from the global popularity and viewing patterns of content.

Embodiments described herein may learn the user profile of each small cell so that the popular content for the cell can be predicted. Assuming a small cell can intercept the content requests from the users in the cell, over a long period of time, the cell can learn the preference of the users in the cell.

The users' content requests may contain, directly or indirectly, parameters related to user profile, such as category preference, location and time preferences. The parameters of each request for a user may update the user's profile, for example, the category of a new requested content may update the category preference of the user.

Under a statistical learning problem, there may be mainly two types of data inputs, one is batch data and the other is stream data. Table 2 presents some difference between batch and streaming learning that may affect the way evaluation may be performed. While batch learners may build static models from finite, static, identically and independently distributed (i.i.d.) data sets, stream learners may need to build models that evolve over time, being therefore dependent on the order of example, and are generated from a continuous non-stationary flow of non-i.i.d. data.

TABLE 2

| | Batch | Stream |
|---|---|---|
| Data Size | Finite data set | Continuous flow |
| Data Distribution | i.i.d. | Non-i.i.d. |
| Data Evolution | Static | Non-stationary |
| Model Building | Batch | Incremental |
| Model Stability | Static | Evolving |
| Order of Observations | Independent | Dependent |

The data steam problem may be studied with a sequence of non-stationary data, in which the data model is evolving. A sliding window (or a forgetting factor) may be applied to the data sequence to reflect the model change over time. The detection of the model change may be based on two sliding windows, one short and one large.

The learning of user profile in a small cell network may be based on a stream of data, such as a sequence of content request arrivals. The requests may be generated based on an evolving data model over time. Two learning factors may be most important: one is the convergent rate of learning and the other is the accuracy of the estimation (the result of learning). In an example, the normal approach may be used for non-stationary stream data by applying a sliding window (or a fading factor). If a model changes slowly, a bigger window size may be used to obtain higher accuracy. If a model changes quickly, a smaller window size may be used to adapt the model.

Embodiments described herein may find the cell profile of a given small cell based on a sequence of content requests, collected by the mobile-CDN service over the whole mobile network. The cell profile can be used to produce the pre-fetching list of content for managed caching placement in the small cell. A challenge may be, for each small cell, there may be a very limited number of content requests, which may not be enough to statistically learn a stable cell profile for the small cell.

More specifically, embodiments may enlarge the statistical data space (or the number of past content requests) for cell profile estimation. A first method may be to identify a set of active users in a small cell and build the cell profile by using all content requests from this set of users, regardless of their locations (over multiple small cells). The cell profile may be built using content requests from a set of active users across similar locations. A second method may be to classify mobile users into groups of similar individual profiles and to build a cell profile by using all content requests from user groups that have at least one member being an active user of the cell. A cell profile may be built based on content request data from all users of a mobile-CDN who have the similar profiles to the active users in the cell.

A method and system disclosed herein may use a basic learning algorithm. In an example, let p={pₖ, k=1, . . . , K} may be a parameter of a profile, and r={r(n), n=1, . . . } may be a continuous data stream of content request arrivals.

Assuming a sliding window size T may be known, let N_{T} be the average number of requests over T. The basic algorithm to learn the data model (e.g. a user profile with one parameter—category preference) may be:

$$\begin{matrix}When n < {N}_{T} , & \\ \begin{matrix}{p}_{k} ( n ) = [ {{p}_{k} ( n - 1 )}^{*} ( n - 1 ) + 1 ] / n , & if r ( n ) = k\end{matrix} & Equation ( 11 ) \\ \begin{matrix}{p}_{k} ( n ) = {{p}_{k} ( n - 1 )}^{*} ( n - 1 ) / n , & if r ( n ) \neq k\end{matrix} & Equation ( 12 ) \\ When n \geq {N}_{T} , & \\ \begin{matrix}{p}_{k} ( n ) = \frac{1}{{N}_{T}} + \frac{{N}_{T} - 1}{{N}_{T}} {p}_{k} ( n - 1 ) , & if r ( n ) = k\end{matrix} & Equation ( 13 ) \\ \begin{matrix}{p}_{k} ( n ) = \frac{{N}_{T} - 1}{{N}_{T}} {p}_{k} ( n - 1 ) , & if r ( n ) \neq k\end{matrix} & Equation ( 14 )\end{matrix}$$

A sliding window may be used in one example, which may be is equivalent to a forgetting mechanism with a fading factor (N_{T}−1)/N_{T}. Further examples may use different fading factor based on experiments. Several fading factors under several examples may not change the nature of the problem.

In an embodiment, Equation (11) may be applied in the algorithm to ensure a fast convergence for a newly identified user. The sliding window size T may reflect the speed of the data model evolving over time. The smaller the T is, the fast the data model may change. On the one hand, a larger window size can provide more data for model estimation; on the other hand, it can reduce the accuracy because the model changes over time. Therefore, in an example the method may not simply increase the window size indefinitely to get more data of content requests.

This may be the conventional algorithm to learn a cell profile, directly using the content requests captured in the cell. In an example, the method can use this basic algorithm to learn the profiles of individual users.

Embodiments may use a time dependent profile. A user profile parameter, such as category preference, can be different at different time periods. For example, in evening peak hours, a movie can be the most preferred among all categories for a given user. In an example, the data stream may be labeled with time slot tags, such as morning, evening, weekend day, weekend night, and the like. Then the profile estimation may be made by only using the content requests with the same label.

The time dependent profile may be more useful for mobile-CDN to make pre-fetching list for edge caching. For example, the mobile-CDN may only want to use peak hours' profile because it may be more accurately reflecting what a user may need during the peak hours.

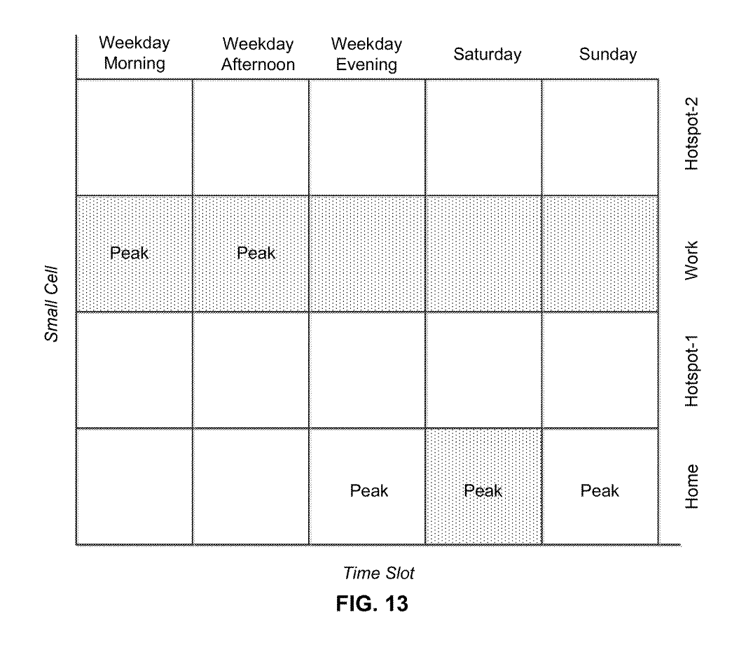

Referring now to FIG. 13, a diagram of a data space for profile learning is shown. The time dependency may further reduce the available data to build the user profile. As shown in FIG. 13, without time slots, the data space for the small cell at work may include all requests at any time. In an example, with the choice of Saturday at home (it may have a different profile from other time slots), the data space may be reduced to requests for Saturday only.

Embodiments may aggregate from individual profiles across multiple cells. Instead of creating a cell profile by only the data from the same cell, the method may apply the algorithm to use the data from the active visitors in the cell across all locations. In an example, the method may apply the basic algorithm to active user-j, and obtain his/her profile pⱼ(nⱼ) at rⱼ(nⱼ)'s arrival. The method may use a weighted sum to estimate the cell profile if the method knows a request count set c={cⱼ} for active users. One exemplary embodiment is to define active users as user-j whose cⱼ>Cₘᵢₙ, a minimum number of requests, during sliding window T.

p(n)=Σcⱼ/|c|*pⱼ(nⱼ) Equation (15)

Where n=Σⱼnⱼ, |c| may be the total number of content requests from active users. Each user may have a different sliding window size in number of requests, but we only aggregate the most recent estimation of each user profile, at nⱼth request arrival for user-j, weighted by the normalized request count over a common sliding window in time T.

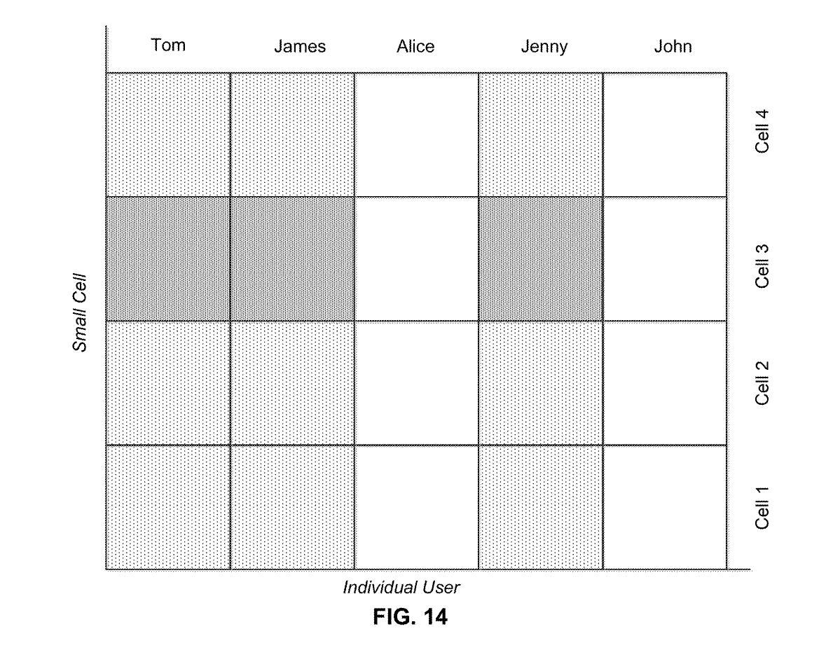

Referring now to FIG. 14, a diagram of a data space expansion by individual user aggregation is shown. Another way to aggregate may be to directly use a cascade data set r={rⱼ(nⱼ), all j if cⱼ ∈c}, sorted in arrival time as {r(n)}, which include all content requests from active users, regardless of locations. As illustrated by the example in FIG. 14, small cell-3 has active users (for example, Tom, James and Jenny), and the data space may be expanded from the three red boxes in cell-3 to three blue boxes across all locations.

The method may use the Equations (11-14) above to learn the cell profile based on this new data set r={r(n)}.

With the same sliding window size T, now the number of average request arrivals N_{T} may be bigger because it is the request count for all active users of a small cell, across all locations they access. One problem may be that different users may have different sliding window size Tⱼ. One exemplary embodiment is to use the average sliding window size of all active users in the small cell.

In an embodiment, group profiles of similar users may be aggregated. Using individual user profile aggregation approaches as described above may obtain a better cell profile estimation due to a larger data space for learning algorithm. However, the expansion may be limited. In an example, the method may use aggregation of group profiles to expand the data space to a large number of users who have the similar profiles to the active users in the small cell.

First, based on the individual profile set P=pⱼ(nⱼ), {where j may be all users in a mobile-CDN}, the mobile-CDN service may classify P into multiple disjoint groups, P=∪Pₘ. Then a subset P^{v}⊂P for a small cell-v may be found. The subset may include every group that has at least one member as the active user in the cell-v.

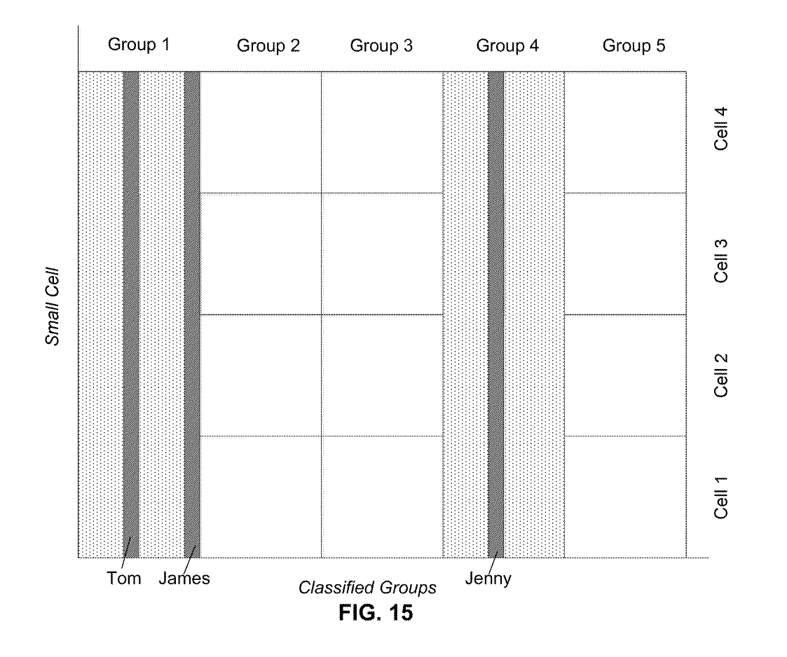

Referring now to FIG. 15, a diagram of a data space expansion by user group aggregation is shown. In an example, the method may use an expanded data space to P′ as shown in FIG. 15 to learn the profile of a small cell, which may include all content requests from users who have similar profiles with Tom, James or Jenny.

In an embodiment, Cₘ may be the total request count from group-m during the last sliding window T time, and C_{m,v} may be the request count from the active users of cell-v who belong to group-m during last T. The weight for each request from group-m may be wₘ=[C_{m,v}/Cₘ]/[ΣᵥC_{m,v}/ΣₘCₘ], which may be the request count ratio of the cell-v in a given group-m normalized by the request count ratio of the cell-v in all groups in P^{v}.

In an example, the method may aggregate the group profiles with corresponding weights as follows:

p(n)=Σwₘ*pₘ(nₘ) Equation (16)

In the above, the following may apply: n=Σₘ nₘ. Also, pₘ(nₘ) may be the group profile learned by equations the equations described above. Each user may have a different sliding window size, but the method may only aggregate the most recent estimation of each user profile, at nₘth request arrival for group-m. The aggregated cell profile may be updated by nth request arrival from all groups who have a member in the cell.

Similar to individual user profile aggregation, in an example, the method may also directly use an expanded request set is r(n)={{rₘ(nₘ)}, all group m that Pₘ ∈P^{v}} to learn the cell profile. The method may apply an appropriate weight on each request arrival to update the cell profile. The algorithm may be used as follows.

For each request arrival r(n), if it may be from a user in group-m, let w=wₘ, the normalized request count ratio of group-m vs. all groups in P^{v}. If wₘ may not be available for a new group-m, the method may choose the average weight, that is, w=1.

$$\begin{matrix}When n < {N}_{T} , ( {N}_{T} = {T}^{*} {\sum }_{m} {C}_{m} ) & \\ \begin{matrix}{p}_{k} ( n ) = [ {{p}_{k} ( n - 1 )}^{*} ( n - w ) + w ] / n , & if r ( n ) = k\end{matrix} & Equation ( 17 ) \\ \begin{matrix}{p}_{k} ( n ) = {{p}_{k} ( n - 1 )}^{*} ( n - w ) / n , & if r ( n ) \neq k\end{matrix} & Equation ( 18 ) \\ When n \geq {N}_{T} , & \\ \begin{matrix}{p}_{k} ( n ) = \frac{w}{{N}_{T}} + \frac{{N}_{T} - w}{{N}_{T}} {p}_{k} ( n - 1 ) , & if r ( n ) = k\end{matrix} & Equation ( 19 ) \\ \begin{matrix}{p}_{k} ( n ) = \frac{{N}_{T} - w}{{N}_{T}} {p}_{k} ( n - 1 ) , & if r ( n ) \neq k\end{matrix} & Equation ( 20 )\end{matrix}$$

On average, each new request arrival may count for 1/N_{T} probability contribution. When a group-m may have a weight more than average, its weight w may be bigger than 1, contributing w/N_{T} to probability distribution. Otherwise, when group-m may have a weight less than average, each request arrival may contribute less than average to the probability distribution.

The above exemplary embodiment may use the same sliding window size for group profiles and the aggregated cell profile learnings. Another exemplary embodiment may use a larger sliding window size for group profile learning but a smaller sliding window size for cell profile learning using requests from groups. This may be based on the assumption that group classification, as a bigger set, changes much slower than cell profile changes. This can help the method, on the one hand, get enough data to classify individual users into groups, and on the other hand, get a responsive cell profile reflecting the fast change of data model.

In an embodiment, a system may be built that emulates a use case of video on demand service. A HTTP proxy server running at the small cell eNode B may intercept users' video requests and learn the preferred categories of the active users under the small cell.

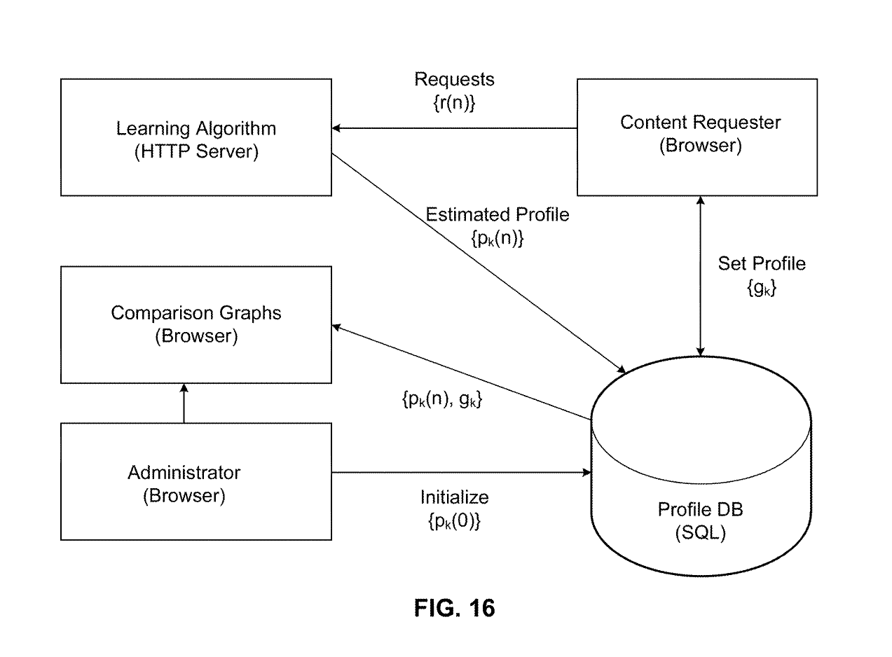

Referring now to FIG. 16, a diagram of an emulation system setup is shown. A web application with the learning algorithm may receive content requests tagged with a category from a content requester. The content requester may be a Javascript program running in a browser, which may generate a sequence of content requests {r(n)} tagged by category-k according to the probability distribution of the preset cell profile {gₖ}. The learning algorithm may estimate the cell profile p(n)={pₖ(n)} based on request arrivals {r(n)} using Equations (11-14). When n<N_{T}, the sliding window size, Equations (11-12) may be applied; and when n≧N_{T}, Equations (13-14) may be applied.

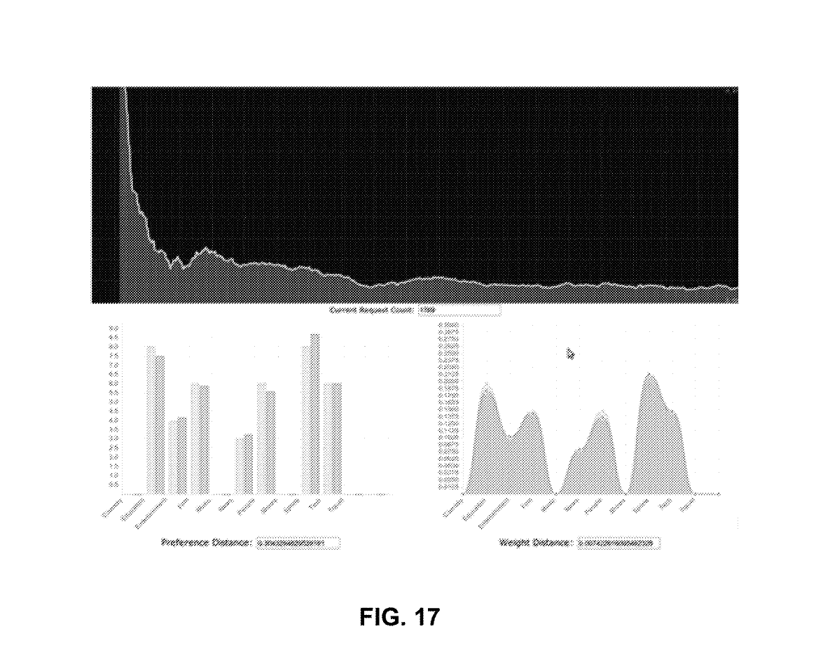

Referring now to FIG. 17, a diagram of example profile learning results is shown. The learning results {pₖ(n)} may be compared with the preset model {gₖ}, shown via graphics. The bottom left may show the differences between the estimated scale (0-10) of the category preference versus the actual scale of category preference. The bottom right may show the difference on normalized category preference. And the top may show the convergence of mean square error on cell profile as the number of request arrivals increases.

FIG. 17 shows an example simulation with 7 preferred categories and a sliding window size of N_{T}=1000. The total request arrivals are n=1769. As seen in the example, the error may drop under 10% after n=20, under 3% after n=100 and slowly drop to 1% until n=1000. Further, after n=1000, the mean square error of estimation may be stable at a little below 1% and may not go down further. The observations may include that the profile learning may converge fast at the beginning and then slow down. Further, the error may not further reduce after sliding window size N_{T}. If we want to keep the error below 3%, about 100 request arrivals may be needed. For each individual user in a small cell, it may take weeks or even months to reach 100 requests for big video content (worth to be cached). For a given time period T, the bigger the N_{T}, the faster the profile estimation may converge.

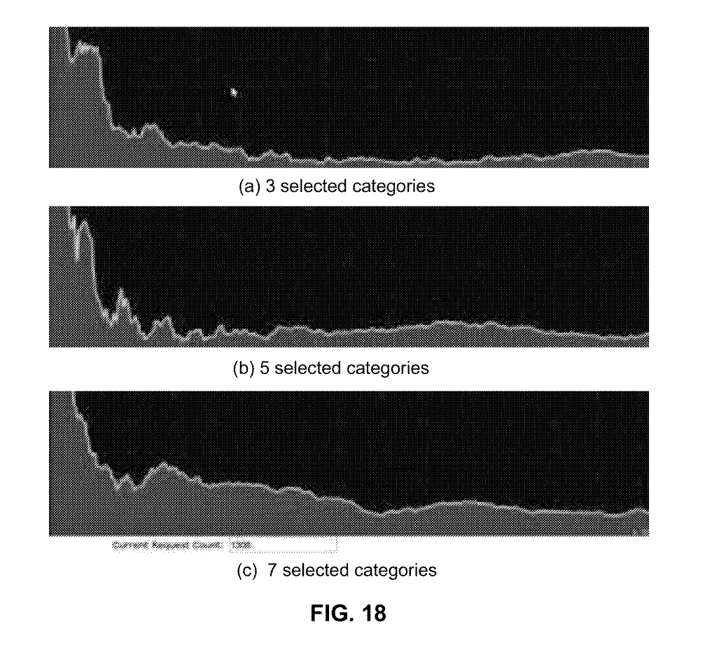

Referring now to FIG. 18, a diagram of an example of a convergence of estimation error on profile learning is shown. FIG. 18 illustrates that the estimation error convergence rate may depend on the number of parameter to be estimated. Each grid in y-axis of FIG. 18 may represent 1% of error. The error of 3 preferred-categories in (a) may be bigger at the beginning, about 5% at n<150; but later may converge to a smaller error 0.5% at n<700. If, in an example, the method may select 5 preferred categories, the error may reduce a little faster at the beginning, 5% at n<100, but may converge to a larger error 1% at n=700. For 7 selected preferred categories, the error may reduce a little faster at the beginning, but the error may still be greater than 1% at n=700.

This profile learning emulation system may demonstrate the needs of increasing a number of request arrivals as the learning dataset in order to have the estimation error converge to a stable value. Since the number of active users in a small cell may be limited, these users may generate limited number of video-on-demand (VoD) requests. For example, a user may watch a couple of movie a week at most. In order to build a cell profile fast and adaptive to changes over time, the method may utilize the request arrivals from other cells of the active users and from users similar to active users.

There may be two types of small cells, home and public hot spots. For home, there may be very few users but the stationary period T can be longer. In this case, maybe the sliding window N_{T} can be enough after months, but the VoD system may need to have a good profile estimation for their new customers in just few days. For public hot spots, the number of users may be more but the stationary period T may be much shorter. In this case, the hot spot eNodeB may want to refresh its cache every day so the method may need more request data for each day. The requirements in both home and public hotspot small cells may be met by applying the methods and systems disclosed herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of pre-fetching content in a small cell network (SCN) by a mobile-content distribution/delivery network (CDN) service, the method comprising:
determining a local popularity for a unit of content within the SCN based on one or more of a global popularity of the unit of content and a global popularity of a category of the unit of content obtained from a content owner in a global network and a local popularity of the category of the unit of content obtained from a base station in the SCN;
determining a local viewing pattern for the unit of content based on one or more of a global viewing pattern of the unit of content and a global viewing pattern of the category of the unit of content obtained from a content owner in the global network and a local viewing pattern of the category of the unit of content obtained from usage data in the SCN; and
transmitting a recommendation of content to an edge server in the SCN based on the local content popularity and local content viewing pattern.

2. The method of claim 1, wherein the mobile-CDN service has a first interface with an edge cache in the SCN and a second interface with a content owner server in the global network.

3. The method of claim 1, wherein the determining the local content popularity comprises multiplying the global popularity of the unit of content by a ratio of the local popularity of the category of the unit of content divided over the global popularity of a category of the unit of content.

4. The method of claim 1, wherein a ratio of a popularity the unit of content to a category of the unit of content is an invariant among the global network and the SCN.

5. The method of claim 1, wherein an offset of a viewing pattern of the unit of content from a category average of the unit of content is an invariant among the global network and the SCN.

6. A method of pre-fetching content in a small cell network (SCN) by a mobile-content distribution/delivery network (CDN) service, the method comprising:
tracking individual user content requests based on a correlation of a network level identifier to an application level identifier; and
building an individual user profile.

7. The method of claim 6, wherein the mobile-CDN service has a first interface with an edge cache and a second interface with a content owner server.

8. The method of claim 6, wherein the network level identifier and the application level identifier update at different times.

9. The method of claim 6, wherein the application level identifier comprises a cookie in a HTTP header.

10. The method of claim 6, wherein the network level identifier comprises an Internet Protocol (IP) address.

11. The method of claim 6, further comprising:
identifying a content request from an existing user with an internal identifier (ID) managed by the mobile-CDN service.

12. The method of claim 6, further comprising:
classifying individual users as frequent visitors and infrequent visitors;
classifying the frequent visitors into active visitors and inactive visitors; and
creating a cell profile from the active frequent visitors.

13. The method of claim 6, wherein the network level identifier and the application level identifier are intercepted by an edge cache proxy.

14. The method of claim 6, wherein the network level identifier and the application level identifier comprise anonymous identifiers of a user.

15. A method of pre-fetching content in a small cell network (SCN) by a mobile-content distribution/delivery network (CDN) service, the method comprising:
identifying active users in a small cell;
generating individual user profiles based on content requests from the active users in the small cell; and
building a cell profile based on individual profiles of active users.

16. The method of claim 15, wherein the building the cell profile comprises using a sliding window mechanism to estimate content requests.

17. The method of claim 15, wherein the sliding window mechanism comprises an average sliding window size of all active users in the small cell.

18. The method of claim 15, further comprising:
aggregating data from an individual active user in the small cell with data from one or more additional small cells to generate the user profile of the individual active user.

19. The method of claim 15, further comprising:
classifying users in a mobile network into groups of similar individual profiles, wherein the small cell is part of the mobile network;
aggregating data from an individual active user in the small cell with data from the users in the mobile network, wherein the users in the mobile network have similar classified user profiles across a at least part of the mobile network; and
using the aggregated data to build the individual profile for the individual active user.

20. The method of claim 15, wherein the mobile-CDN service has a first interface with an edge cache and a second interface with a content owner server.
